(19) United States
(12) Patent Application Publication
(10) Pub. No.: US 2017/0275814 A1
(43) Pub. Date: Sep. 28, 2017

(54) METHOD FOR COLORING A SUBSTRATE USING ATMOSPHERIC PRESSURE PLASMA POLYMERIZATION

(71) Applicant: Apjet, Inc., Morrisville, NC (US)

(72) Inventors: Carrie E. Cornelius, Durham, NC (US); James B. McNeill, III, Apex, NC (US)

(73) Assignee: Apjet, Inc., Morrisville, NC (US)

(21) Appl. No.: 15/468,056

(22) Filed: Mar. 23, 2017

Related U.S. Application Data
(60) Provisional application No. 62/312,685, filed on Mar. 24, 2016.

(51) Int. Cl. D06P 1/00; C09D 135/02; C09D 133/14; C09D 5/14; C09D 5/18; D06P 5/20; C09D 11/106; C09D 11/107; D06P 1/04; D06P 3/60; D06P 3/34; D06P 3/04; C09D 133/26; C09D 11/328

(52) U.S. Cl. CPC D06P 1/0052; C09D 133/26; C09D 135/02; C09D 133/14; C09D 5/14; C09D 5/18; C09D 11/328; C09D 11/106; C09D 11/107; D06P 1/04; D06P 3/6058; D06P 3/346; D06P 3/047; D06P 5/2016

(57) ABSTRACT

Methods for coloration of substrates, including textiles, by plasma polymerization of dyes to which polymerizable moieties have been chemically bonded at sites on the dye capable of bonding to such moieties, and that have been deposited on at least one surface of the substrate, are described. Atmospheric pressure plasmas were used for the polymerization process. Generally, the plasma polymerization is performed away from the dye deposition so that undeposited dye is not exposed to the plasma. Textiles may include cotton, polyester, wool, silk, acrylics, polypropylene, polyolefins, aramids, and nylon, and blends thereof. The plasma-polymerizable moiety may be chosen from acrylates, methacrylates, and vinyl amides. Dye functional groups may include hydroxyl groups, carboxyl groups, amines: primary, secondary, and tertiary, epoxides, carboxylic acids, and chlorides, and dyes may include acid dyes, disperse dyes, azo dyes, vat dyes, sulfur dyes, direct dyes, reactive dyes, basic dyes, pigment dyes, aniline dyes, anthraquinone dyes, and coumarin dyes, as examples.

### CROSS-REFERENCE TO RELATED APPLICATIONS

The present application claims the benefit of U.S. Provisional Patent Application No. 62/312,685 for “Method For Coloring A Substrate Using Atmospheric Pressure Plasma Polymerization” by Carrie E. Cornelius and James B. McNeill III, which was filed on 24 Mar., 2016, the entire content of which patent application is hereby specifically incorporated by reference herein for all that it discloses and teaches.

### BACKGROUND OF THE INVENTION

Coloration of a substrate is the process of applying dyes to color the substrate, for example, textile products such as fibers, yarns, and fabrics. Currently, textiles are placed in contact with a dyebath, which normally includes a delivery system, such as water, dyes, and chemical auxiliaries for improving the coloration process and the properties of the colored textile. The dye is incorporated into or onto the textile fabric or fiber by chemical reaction, absorption, dispersion, or adhesion.

Different classes of dyes are used for different types of fiber and at different stages of textile production. For example, basic dyes are used to dye acrylic fibers, acid dyes are used to dye nylon and protein fibers such as wool and silk, disperse dyes are used to dye polyester fiber, and vat dyes, reactive dyes, and direct dyes are used to dye cotton.

High purity water is required for the color process, with water exiting the textile dyeing process containing as many as 72 toxic chemicals, many of which cannot be filtered or easily removed. According to the U.S. Environmental Protection Agency, an average of 40 liters of water is required for dyeing 1 kg of cloth, changing according to the textile and dyeing process.

### SUMMARY OF THE INVENTION

One embodiment of the present method for coloring a substrate, as embodied and broadly described herein, includes: attaching a plasma-polymerizable moiety to a functional group of a dye capable of receiving the moiety, forming thereby a plasma-polymerizable dye; depositing the plasma-polymerizable dye on at least one surface of the substrate, forming thereby a plasma-polymerizable dye-coated substrate; and exposing the at least one surface of the plasma-polymerizable dye-coated substrate to a plasma.

Another embodiment of the present method for coloring a substrate, includes: attaching a plasma-polymerizable moiety to a functional group of a dye capable of receiving the moiety, forming thereby a plasma-polymerizable dye; dissolving the plasma-polymerizable dye in a nonaqueous solvent therefor, forming a solution; atomizing the solution of the plasma-polymerizable dye onto at least one surface of the substrate, forming thereby a plasma-polymerizable dye-coated substrate; exposing the at least one surface of the plasma-polymerizable dye-coated substrate to an atmospheric pressure plasma; and removing unpolymerized plasma-polymerizable dye from the substrate.

Yet another embodiment of the present method for coloring a substrate, includes: attaching a plasma-polymerizable moiety to a functional group of a dye capable of receiving the moiety, forming thereby a plasma-polymerizable dye; preparing a dispersion of the plasma-polymerizable dye in a nonaqueous liquid; atomizing the dispersion of the plasma-polymerizable dye onto at least one surface of the substrate, forming thereby a plasma-polymerizable dye-coated substrate; exposing the at least one surface of the plasma-polymerizable dye-coated substrate to an atmospheric pressure plasma; and removing unpolymerized plasma-polymerizable dye from the substrate.

Benefits and advantages of embodiments of the present invention include, but are not limited to, providing a method for dyeing substrates, such as fabrics, using an atmospheric pressure plasma and polymerizable moieties chemically bonded to various dyes, without requiring water or heat.

### DETAILED DESCRIPTION OF THE INVENTION

Briefly, embodiments of the present invention include coloration of substrates, including textiles, by plasma polymerization of dyes to which polymerizable moieties have been chemically bonded at sites on the dye capable of bonding to such moieties, that have been deposited on at least one surface of the substrate. Atmospheric pressure plasmas were used for the polymerization process, although sub-atmospheric pressure plasmas are expected to be effective for some systems. Generally, the plasma polymerization is performed away from the dye deposition so that undeposited dye is not exposed to the plasma.

Textiles may include cotton, polyester, wool, silk, acrylics, polypropylene, polyolefins, aramids, and nylon, and blends thereof. The plasma-polymerizable moiety may be chosen from acrylates, methacrylates, and vinyl amides. Dye functional groups may include hydroxyl groups, carboxyl groups, amines: primary, secondary, and tertiary, epoxides, carboxylic adds, and chlorides, and dyes may include add dyes, disperse dyes, azo dyes, vat dyes, sulfur dyes, direct dyes, reactive dyes, basic dyes, pigment dyes, aniline dyes, anthraquinone dyes, and coumarin dyes, as examples.

As an example of this process, an acrylate moiety can be formed by reacting starting compounds such as

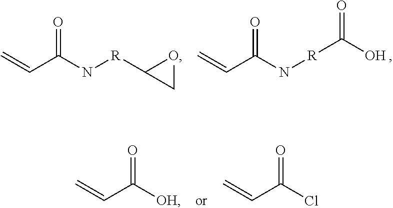

with the hydrogen at the site of the secondary amine for disperse dye, Disperse Red 9,

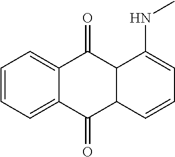 [SMILES: CNC1=CC=CC2C(=O)c3ccccc3C(=O)C12]

to form:

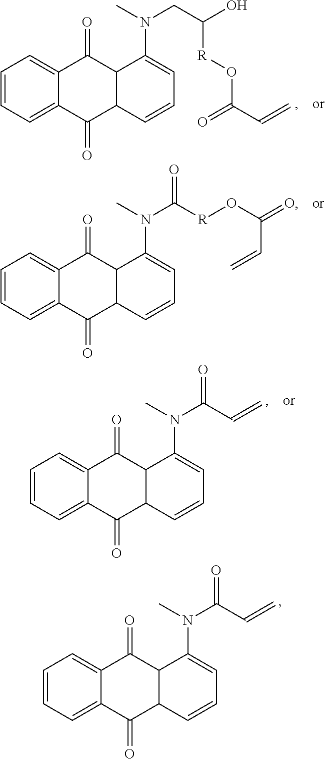

respectively.
The acrylamides:

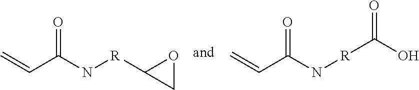

may also be utilized.
R groups may include no or one or more carbon atoms in linear or branched configurations, as examples, and mare complex groups may be used to provide additional functionality, such as flame retardancy, antimicrobial functions, water/oil repellency, etc. When reacted with a dye molecule, the new compound might have multiple functionalities (for example, color and flame retardancy). Other methods for achieving additional functionality will be discussed below.

An example of a dye having an accessible carboxylic add is Coumarin 343.

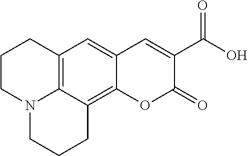 [SMILES: O=C(O)c1cc2cc3c4c(c2oc1=O)CCCN4CCC3]

Examples of dyes having available hydroxyl groups are disperse dyes, such as Disperse Yellow 1, and azo dyes, such as Allura Red,

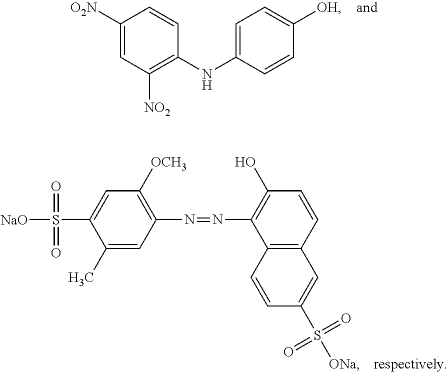

The plasma-polymerizable moieties are covalently bonded to the dye. An auxochrome is a functional group of atoms having nonbonded electrons, which when attached to a chromophore, alters both the wavelength and intensity of absorption. If these groups are in direct conjugation with the pi-system of the chromophore, they may increase the wavelength at which the light is absorbed and, as a result, intensify the absorption. A feature of these auxochromes is the presence of at least one lone pair of electrons which can be viewed as extending the conjugated system by resonance. As stated above, acrylate moieties can bond to hydroxyl, carboxylic acid, and amines. A bathochromic shift (effect) is a shift of a spectral band to lower frequencies (longer wavelengths, or red shift) owing to the influence of substitution or a change in environment. When changing the auxochrome, a wavelength shift can occur. For example, changing the primary amine to a secondary amine will cause a bathochromic shift of about 60 nm, while changing an alcohol group to an ether causes a bathochromic shift of about 6 nm. Replacing the hydrogen with an acrylate moiety on carboxylic acid group of a dye should not cause a shift in wavelength. Once the plasma-polymerizable dye is synthesized, its color can be determined and catalogued for use.

It is anticipated by the present inventors that various compositions may be mixed with the plasma-polymerizable dye to impart additional functionality to the substrate coating such as wicking properties, antimicrobial behavior, water repellency and flame retardance, as examples. The mixture of chemicals, including the plasma-polymerizable dye, would be applied to the substrate, and plasma cured. In the event that the materials do not mix well, they might be applied one at a time before the curing process.

For antimicrobial functionality, 2,4-dicholorophenyl acrylate, (3 acrylamidopropyl)trimethylammonium chloride, 4-(2-thiocyanato-3-acryl propionyloxy) butyl acrylates, and Diallyldimethyl ammonium chloride, as examples, may be used individually, or in various combinations.

As wicking/hydrophilic agents, Di(ethylene glycol) acrylates, and Glycerol 1,3 dicglycerolate diacrylate may be used individually, or in various combinations.

Fluorinated and non-fluorinated water repellent compounds may include Stearyl acrylate, Lauryl acrylate, Behenyl acrylate, Perfluorinated acrylates, and Silicone acrylates, individually and in various combinations.

For flame retardants, 2,3,4,5,6-pentabromobenzyl acrylate, Phosphate acrylates, Phosphonium acrylates, and Phosphonate acrylates, as examples, may be used individually or in combination.

Having generally described the present invention, the following EXAMPLES are set forth to provide additional details.

### Examples

In what follows, the atmospheric plasma apparatus described in U.S. Patent Application Publication No. US 2014/0076861 A1, for “Atmospheric-Pressure Plasma Processing Apparatus And Method,” by Carrie E. Cornelius et al., Published on Mar. 20, 2014, was utilized. Typical process conditions for plasma dyeing in a roll-to-roll system in accordance with the teachings of embodiments of the present invention, include:
A process gas dose of 150 L/Yd² of He/N₂ gas blend (98.5% He, 1.5% N2);
A power density of 16 W/cm³ at a frequency of 13.56 Hz;
An electrode-to-fabric spacing of 0.5 to 2.0 mm;
Spray application of materials to the substrate;
A dose of applied dye of 0.1 to 2.0% by weight of fabric; and
After plasma polymerizable materials are applied to the fabric, the treated fabric is moved into the plasma region.

In order to test the ability of atmospheric pressure plasma to dye fabric, plasma-polymerizable dyes were synthesized and applied to three fabrics: nylon, cotton, and polyester. The dye was dissolved in a nonaqueous solvent, which may include alcohols, acetates, ketones, alkyl benzenes, alkanes, and glycols, and combinations thereof, with similar compositions for the nonaqueous liquids, and applied to both sides of the fabric using atomizing nozzles. The fabric was then passed through the atmospheric pressure plasma apparatus described above, and plasma treated to polymerize and bind the dye to the fabric. Control fabric samples were sprayed with dye but not exposed to plasma. The efficacy of plasma dyeing was tested by extracting dyed fabric treated with and without plasma using Soxhlet extractors and solvents, which may include alcohols, acetates, ketones, alkyl benzenes, alkanes, and glycols, and combinations thereof.

Three fabric types were selected for dyeing, a 100% polyester poplin, 100% plain-weave cotton and 100% rip-stop nylon fabric, as shown in the TABLE. All fabrics were obtained from Test Fabrics and contained no dye or finish.

TABLE

| | Style Number | Weave type | Weight (g/yd²) |
|---|---|---|---|
| 100% Cotton | #400 | Plain weave | 85 |
| 100% Nylon | 70D rip-stop | Rip-stop | 53 |
| 100% Polyester | #700-5 | Polypoplin | 105 |

Three plasma-polymerizable dyes with two different plasma-polymerizable groups were evaluated. The plasma-polymerizable groups are circled.

### Pre-curser Dye, Disperse Orange 3

### Color: Orange

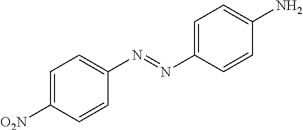 [SMILES: Nc1ccc(/N=N/c2ccc([N+](=O)[O-])cc2)cc1]

Plasma-curable Dye Synthesized from Pre-curser Dye Disperse Orange 3
Color: Yellow/Orange. Shift in color occurs towards yellow, due to the bathochromatic shift.

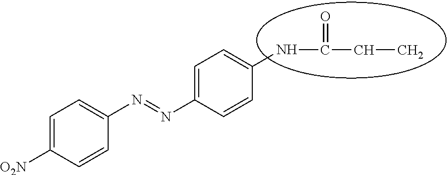 [SMILES: CCC(=O)Nc1ccc(/N=N/c2ccc([N+](=O)[O-])cc2)cc1]

### Pre-curser Dye, Disperse Red 17

### Color: Red

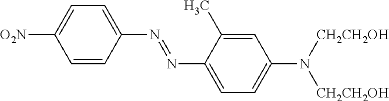

Plasma-curable Dye Synthesized from Pre-curser Dye Disperse Red 17

### Color: Red

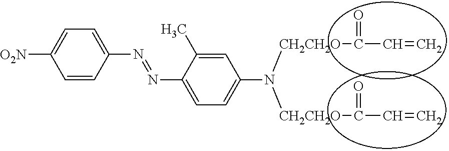

### Pre-cursor Dye, Disperse Black 9

### Color: Black

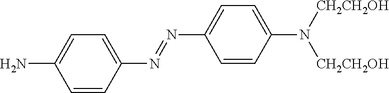

Plasma-curable Dye Synthesized from Pre-curser Dye Disperse Black 9
Color: Yellow. Shift in color occurs to yellow, due to the bathochromatic shift.

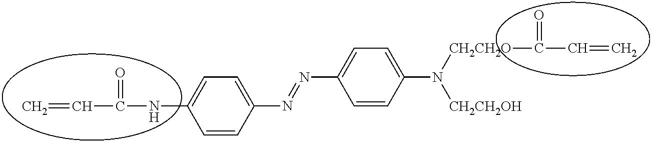

After application of the dye and plasma treatment, samples were washed in solvent to remove any dye contaminant incapable of plasma-polymerization, and any unreacted dye monomer. As an example, samples were washed using Soxhlet extraction with 99.9% Isopropanol (Sigma Aldrich), Samples were extracted until all dye was removed, as evidenced by the extraction liquid remaining clear for a minimum of two washing steps.

All samples sprayed with dyes changed colors, but only the samples that were treated with plasma retained coloration after the solvent extraction. The cotton, nylon, and polyester fabrics were successfully dyed by all three plasma-polymerizable dye compounds. In addition, both plasma-polymerizable groups were shown to be capable of polymerization by plasma.

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method for coloring a substrate, comprising:
attaching a plasma-polymerizable moiety to a functional group of a dye capable of receiving said moiety, forming thereby a plasma-polymerizable dye;
depositing said plasma-polymerizable dye on at least one surface of said substrate, forming thereby a plasma-polymerizable dye-coated substrate; and
exposing said at least one surface of said plasma-polymerizable dye-coated substrate to a plasma.

2. The method of claim 1, wherein said step of depositing said plasma-polymerizable dye on at least one surface of said substrate, is isolated from said step of exposing said at least one surface of said plasma-polymerizable dye-coated substrate to a plasma, whereby undeposited plasma-polymerizable dye is not exposed to the plasma.

3. The method of claim 2, wherein said step of depositing said plasma-polymerizable dye on at least one surface of said substrate is performed in a first chamber.

4. The method of claim 1, wherein said step of depositing said plasma-polymerizable dye on said at least one surface of said substrate comprises: dissolving said plasma-polymerizable dye in a solvent therefor, forming a solution; and applying said solution to at least one surface of said substrate.

5. The method of claim 4, wherein said solvent comprises a non-aqueous solvent.

6. The method of claim 4, wherein said step of applying said solution to at least one surface of said substrate is chosen from spraying, rolling, ink-jet printing, and painting said solution onto at least one surface of said substrate.

7. The method of claim 6, wherein said step of spraying said solution onto at least one surface of said substrate comprises atomizing said solution.

8. The method of claim 1, wherein said step of exposing said at least one surface of said plasma-polymerizable dye-coated substrate to a plasma comprises exposing said at least one surface of said plasma-polymerizable dye coated substrate to an atmospheric pressure plasma.

9. The method of claim 1, wherein said step of depositing said plasma-polymerizable dye on said at least one surface of said substrate comprises: preparing a dispersion of said plasma-polymerizable dye in a liquid; and applying said dispersion to at least one surface of said substrate.

10. The method of claim 9, wherein said liquid comprises a non-aqueous liquid.

11. The method of claim 9, wherein said step of applying said dispersion to at least one surface of said substrate is chosen from spraying, rolling, ink-jet printing, and painting said dispersion onto at least one surface of said substrate.

12. The method of claim 9, wherein said step of spraying said dispersion onto at least one surface of said substrate comprises atomizing said dispersion.

13. The method of claim 1, wherein said substrate comprises textiles.

14. The method of claim 13, wherein said textiles are chosen from fibers, yarns, and fabrics.

15. The method of claim 14, wherein said fibers are chosen from cotton, polyester, wool, silk, acrylics, polypropylene, polyolefins, aramids, and nylon, and blends thereof.

16. The method of claim 1, wherein said step of attaching a plasma-polymerizable moiety to a functional group on a dye capable of receiving said moiety, comprises reacting said plasma-polymerizable moiety with said functional group, whereby said plasma-polymerizable moiety is covalently bonded to said dye.

17. The method of claim 16, wherein said plasma-polymerizable moiety is chosen from acrylates, methacrylates, and vinyl amides.

18. The method of claim 16, wherein the functional groups of said dye are chosen from hydroxyl groups, amines: primary, secondary, and tertiary, epoxides, carboxylic acids, and chlorides.

19. The method of claim 1, wherein said dye is chosen from acid dyes, disperse dyes, azo dyes, vat dyes, sulfur dyes, direct dyes, reactive dyes, basic dyes, pigment dyes, aniline dyes, anthraquinone dyes, and coumarin dyes.

20. The method of claim 1, further comprising the step of removing unpolymerized plasma-polymerizable dye from said substrate.

21. The method of claim 20, wherein said step of removing unpolymerized plasma-polymerizable dye from said substrate comprises washing said substrate with a solvent.

22. The method of claim 21, wherein said solvent is chosen from alcohols, acetates, ketones, alkyl benzenes, alkanes, and glycols.

23. The method of claim 1, wherein said steps of depositing said plasma-polymerizable dye on at least one surface of said substrate, and exposing said at least one surface of said plasma-polymerizable dye-coated substrate to a plasma are continuous.

24. The method of claim 1, further comprising the step of mixing an antimicrobial agent with said plasma-polymerizable dye before said step of depositing said plasma-polymerizable dye on at least one surface of said substrate.

25. The method of claim 24, wherein said antimicrobial agent is chosen from 2,4-dicholorophenyl acrylate, (3-acrylamidopropyl)trimethylammonium chloride, 4-(2-thiocyanato-3-acryl propionyloxy) butyl acrylate, Diallyldimethyl ammonium chloride, and combinations thereof.

26. The method of claim 1, further comprising the step of depositing an antimicrobial agent on at least one surface of said substrate before said step of exposing said at least one surface of said plasma-polymerizable dye-coated substrate to a plasma.

27. The method of claim 26, wherein said antimicrobial agent is chosen from 2,4-dicholorophenyl acrylate, (3-acrylamidopropyl)trimethylammonium chloride, 4-(2-thiocyanato-3-acryl propionyloxy) butyl acrylate, Diallyldimethyl ammonium chloride, and combinations thereof.

28. The method of claim 1, further comprising the step of mixing a flame retardant agent with said plasma-polymerizable dye before said step of depositing said plasma-polymerizable dye on at least one surface of said substrate.

29. The method of claim 28, wherein said flame retardant agent is chosen from 2,3,4,5,6-pentabromobenzyl acrylate, Phosphate acrylates, Phosphonium acrylates, Phosphonate acrylates, and combinations thereof.

30. The method of claim 1, further comprising the step of depositing a flame retardant agent on at least one surface of said substrate before said step of exposing said at least one surface of said plasma-polymerizable dye-coated substrate to a plasma.

31. The method of claim 30, wherein said flame retardant agent is chosen from 2,3,4,5,6-pentabromobenzyl acrylate, Phosphate acrylates, Phosphonium acrylates, Phosphonate acrylates, and combinations thereof.

32. The method of claim 1, further comprising the step of mixing a wicking or hydrophilic agent with said plasma-polymerizable dye before said step of depositing said plasma-polymerizable dye on at least one surface of said substrate.

33. The method of claim 32, wherein said wicking or hydrophilic agent is chosen from Di(ethylene glycol) acrylates, Glycerol 1,3 diglycerolate diacrylate, and combinations thereof.

34. The method of claim 1, further comprising the step of depositing a wicking or hydrophilic agent on at least one surface of said substrate before said step of exposing said at least one surface of said plasma-polymerizable dye-coated substrate to a plasma.

35. The method of claim 34, wherein said wicking or hydrophilic agent is chosen from Di(ethylene glycol) acrylates, Glycerol 1,3 diglycerolate diacrylate, and combinations thereof.

36. The method of claim 1, further comprising the step of mixing a repellant agent with said plasma-polymerizable dye before said step of depositing said plasma-polymerizable dye on at least one surface of said substrate.

37. The method of claim 36, wherein said water repellant agent is chosen from Stearyl acrylate, Lauryl acrylate, Behenyl acrylate, Perfluorinated acrylates, Silicone acrylates, and combinations thereof.

38. The method of claim 1, further comprising the step of depositing a water repellant agent on at least one surface of said substrate before said step of exposing said at least one surface of said plasma-polymerizable dye-coated substrate to a plasma.

39. The method of claim 38, wherein said water repellant agent is chosen from Stearyl acrylate, Lauryl acrylate, Behenyl acrylate, Perfluorinated acrylates, Silicone acrylates, and combinations thereof.

40. A method for coloring a substrate, comprising:
attaching a plasma-polymerizable moiety to a functional group of a dye capable of receiving said moiety, forming thereby a plasma-polymerizable dye;
dissolving said plasma-polymerizable dye in a nonaqueous solvent therefor, forming a solution;
atomizing said solution of said plasma-polymerizable dye onto at least one surface of said substrate, forming thereby a plasma-polymerizable dye-coated substrate;
exposing said at least one surface of said plasma-polymerizable dye-coated substrate to an atmospheric pressure plasma; and
removing unpolymerized plasma-polymerizable dye from said substrate.

41. The method of claim 40, wherein said step of depositing said plasma-polymerizable dye on at least one surface of said substrate, is isolated from said step of exposing said at least one surface of said plasma-polymerizable dye-coated substrate to a plasma, whereby undeposited plasma-polymerizable dye is not exposed to the plasma.

42. The method of claim 41, wherein said step of depositing said plasma-polymerizable dye on at least one surface of said substrate is performed in a first chamber.

43. The method of claim 40, wherein said substrate comprises textiles.

44. The method of claim 43, wherein said textiles are chosen from fibers, yarns, and fabrics.

45. The method of claim 44, wherein said fibers are chosen from cotton, polyester, wool, silk, acrylics, polypropylene, polyolefins, aramids, and nylon, and blends thereof.

46. The method of claim 40, wherein said step of attaching a plasma-polymerizable moiety to a functional group on a dye capable of receiving said moiety, comprises reacting said plasma-polymerizable moiety with said functional group, whereby said plasma-polymerizable moiety is covalently bonded to said dye.

47. The method of claim 46, wherein said plasma-polymerizable moiety is chosen from acrylates, methacrylates, and vinyl amides.

48. The method of claim 46, wherein the functional groups of said dye are chosen from hydroxyl groups, amines: primary, secondary, and tertiary, epoxides, carboxylic acids, and chlorides.

49. The method of claim 40, wherein said dye is chosen from acid dyes, disperse dyes, azo dyes, vat dyes, sulfur dyes, direct dyes, reactive dyes, basic dyes, pigment dyes, aniline dyes, anthraquinone dyes, and coumarin dyes.

50. The method of claim 40, wherein said step of removing unpolymerized plasma-polymerizable dye from said substrate comprises washing said substrate with a solvent.

51. The method of claim 50, wherein said solvent is chosen from alcohols, acetates, ketones, alkyl benzenes, alkanes, glycols, and combinations thereof.

52. A method for coloring a substrate, comprising:
attaching a plasma-polymerizable moiety to a functional group of a dye capable of receiving said moiety, forming thereby a plasma-polymerizable dye;
preparing a dispersion of said plasma-polymerizable dye in a nonaqueous liquid;
atomizing said dispersion of said plasma-polymerizable dye onto at least one surface of said substrate, forming thereby a plasma-polymerizable dye-coated substrate;
exposing said at least one surface of said plasma-polymerizable dye-coated substrate to an atmospheric pressure plasma; and
removing unpolymerized plasma-polymerizable dye from said substrate.

53. The method of claim 52, wherein said step of depositing said plasma-polymerizable dye on at least one surface of said substrate, is isolated from said step of exposing said at least one surface of said plasma-polymerizable dye-coated substrate to a plasma, whereby undeposited plasma-polymerizable dye is not exposed to the plasma.

54. The method of claim 53, wherein said step of depositing said plasma-polymerizable dye on at least one surface of said substrate is performed in a first chamber.

55. The method of claim 52, wherein said substrate comprises textiles.

56. The method of claim 55, wherein said textiles are chosen from fibers, yarns, and fabrics.

57. The method of claim 56, wherein said fibers are chosen from cotton, polyester, wool, silk, acrylics, polypropylene, polyolefins, aramids, and nylon, and blends thereof.

58. The method of claim 52, wherein said step of attaching a plasma-polymerizable moiety to a functional group on a dye capable of receiving said moiety, comprises reacting said plasma-polymerizable moiety with said functional group, whereby said plasma-polymerizable moiety is covalently bonded to said dye.

59. The method of claim 58, wherein said plasma-polymerizable moiety is chosen from acrylates, methacrylates, and vinyl amides.

60. The method of claim 58, wherein the functional groups of said dye are chosen from hydroxyl groups, amines: primary, secondary, and tertiary, epoxides, carboxylic acids, and chlorides.

61. The method of claim 52, wherein said dye is chosen from acid dyes, disperse dyes, azo dyes, vat dyes, sulfur dyes, direct dyes, reactive dyes, basic dyes, pigment dyes, aniline dyes, anthraquinone dyes, and coumarin dyes.

62. The method of claim 52, wherein said step of removing unpolymerized plasma-polymerizable dye from said substrate comprises washing said substrate with a solvent.

63. The method of claim 62, wherein said solvent is chosen from alcohols, acetates, ketones, alkyl benzenes, alkanes, glycols, and combinations thereof.
